(19) United States
(12) Patent Application Publication
(10) Pub. No.: US 2006/0020534 A1
(43) Pub. Date: Jan. 26, 2006

(54) Global Stock Trading with Uniform Monetization

(76) Inventor: George Pieczenik, New York, NY (US)

Correspondence Address: DR. GEORGE PIECZENIK, APT. 1F, 412 EAST 55TH STREET, NEW YORK, NY, 10022, US

(21) Appl. No.: 10/710,540

(22) Filed: Jul. 20, 2004

(51) Int. Cl. G06Q 40/00

(52) U.S. Cl. 705/37

(57) ABSTRACT

A product and method of electronically trading stocks globally on their respective exchanges using a common currency, preferably U.S. currency.

### FEDERAL RESEARCH STATEMENT

[No federal funds were used in developing this inventions]

### BACKGROUND OF INVENTION

Stocks are traded in many countries in many different currencies. For example, the New York Stock Exchange and the NASDAQ trade in U.S. dollars, while the French Stock exchange, Compagnie des Agents de Change 40 (CAC-40), trades in Euros. There is no uniform currency to trade stocks from different stock exchanges. An American trader, for example, cannot trade French stocks in dollar equivalents. At present a trader needs to trade in the currency of each countries stock exchange. For example, if the trader wants the dollar equivalent of the Euro, then he must purchase the equivalent dollars at a currency exchange for Euros.

Patent Application by Inventor Bea Calo No. 20020087454 published Jul. 4, 2002 describes a global trading system. However, this system does not allow trading on global exchanges with a common currency.

### DETAILED DESCRIPTION

There is a clear utility to creating a global trading system that can be traded in a uniform currency preferably the U.S. dollar. This will allow Americans to trade on the French, German, Russian, Chinese, Japanese, Brazilian, Indian, inter alia exchanges in U.S. dollars and will allow foreign nationals to trade in their countries their own stocks in dollars and on the US exchanges in dollars. The utility to for the American trader is easy access and trading in emerging foreign stock exchanges. The utility to foreign traders is to have stock assets in U.S. dollars.

The utility to commerce is to help globalize the stock exchanges of the world into a uniform market.

In the best mode, the common currency is the U.S. dollar.

In other embodiments, the common currency can be the Euro or gold, inter alia The product for global stock trading in a common currency is a novel commercial paper document secured by an individual or corporation to convert the foreign stock price at its price into its dollar equivalent and to pay the bearer of said commercial paper document the U.S. dollar equivalent of the foreign shares owned.

This invention comprises a product which is to be called and defined as a Dollar Equivalent Certificate and abbreviated as DEC.

This invention comprises a method for the uniform trading of foreign securities on their respective foreign stock exchanges comprising the steps of 1) presenting all stocks from all stock exchanges (U.S. and foreign), or a representation of the same, on an electronic trading system, comprising a server and trading platforms which are accessible to a plurality of traders; and 2) wherein, said electronic trading system converts all foreign stocks from all foreign exchanges into their dollar equivalent; and 3) allowing traders to buy and sell these foreign stocks on said electronic trading system in their dollar equivalent; and 4) the step of allowing traders to accept the stock traded in its currency of origin with a dollar equivalent stock certificate (DESC) by 5) allowing the traded stock to be converted into its dollar equivalent, thereby creating a method of uniform trading for global securities in U.S. dollars.

For a specific example, Aventis, a pharmaceutical company trading on the Paris Bourse, traded on Jul. 19, 2004 at 63.70 Euro's. The Euro was trading at 1.174 dollars per Euro. If a trader bought one share of Aventis he would be issued a DESC commercial paper for one stock of Aventis for the dollar equivalent of (63.70 Euros times 1.174 dollars per Euro or) 74.783 dollars. The trader's trading platform and server would show Aventis (Paris) at 74.783 dollars rather than 63.70 Euros as it is shown on its own Paris exchange. At any time he can convert his share of Aventis into dollars by turning over his DESC and Aventis share (Paris), denominated in Euros to the individual, individuals, group or corporation willing to secure this conversion transaction.

For a specific example, Chugai, a pharmaceutical company trading on the Japanese Exchange, traded on Jul. 19, 2004 at 1645 yen. The Yen was trading at 108.79 yen per dollar. If a trader bought one share of Chugai he would be issued a DESC commercial paper for one stock of Chugai for the dollar equivalent of (1645 Yen divided by 108.79 yen per dollar) 15.12 dollars. The trader's trading platform and server would show Chugai (Japan) at 15.12 dollars rather than 1645 Yen as it is shown on its own Japanese exchange. At any time the trader can convert his share of Chugai into dollars by turning over his DESC and Chugai share (Japan), denominated in Yen to the individual, individuals, group or corporation willing to secure this conversion transaction.

In all cases of trading, while the examples above give final quotes for the day, an active ticker on the electronic trading platform and server can show both the bid and ask price for all foreign stocks in dollar equivalents and not just the final day sale price, as well as other pertinent information, inter alia.

1. A commercial paper product for global stock trading in a common currency comprising a novel commercial paper document, to be called a Dollar Equivalent Stock Certificate (DESC) secured by an individual or corporation which allows the bearer to convert the foreign currency stock price into its dollar equivalent and to pay the bearer of said dollar equivalent stock certificate (DESC) the U.S. dollar equivalent of the foreign shares owned.

2. The novel commercial paper document of claim 1 wherein the stock value is secured by Euros.

3. The novel commercial paper document of claim 1 wherein the stock value is secured by gold.

4. This invention comprises a method for the uniform trading of foreign securities on their respective foreign stock exchanges comprising the steps of
1) presenting all stocks from all stock exchanges (U.S. and foreign), or a representation of the same, on an electronic trading system, comprising a server and trading platforms which are accessible to a plurality of traders; and
2) wherein, said electronic trading system converts all foreign stocks from all foreign exchanges into their dollar equivalent; and
3) allowing traders to buy and sell these foreign stocks on said electronic trading system in their dollar equivalent; and
4) the step of allowing traders to accept the stock traded in its currency of origin with a dollar equivalent stock certificate (DESC) by
5) allowing the traded stock to be converted into its dollar equivalent, thereby creating a method of uniform trading for global securities in U.S. dollars.
